(19) United States
(12) Patent Application Publication
(10) Pub. No.: US 2007/0220161 A1
(43) Pub. Date: Sep. 20, 2007

(54) Broadcasting a presentation over a messaging network

(75) Inventors: Kyle T. Richey, Seattle, WA (US); Harold C. Ho, San Jose, CA (US); Nicolas Trescases, Bellevue, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/377,598

(22) Filed: Mar. 15, 2006

(51) Int. Cl. G06F 15/16; G06F 15/173

(52) U.S. Cl. 709/231; 709/238

(57) ABSTRACT

A presentation file is broadcast over a messaging channel during a messaging session. A video signal is generated in response to navigation of the presentation file within a presentation application. An encoded video stream suitable for transmission over a messaging network is derived from the generated video signal. The encoded video stream is transmitted over a messaging channel by a presenter to other members of a messaging session. As the presenter navigates the presentation pages locally, the encoded video stream is updated to provide the corresponding pages of the presentation to the messaging session members. The encoded video stream may be sent by a messaging application associated with a user or a virtual user, and may be embedded or mixed with other user video data.

### BACKGROUND

Software applications communicate business information in several formats and channels. One example of a software application for communicating business information is a presentation application. Presentation applications are used to create, edit and present presentation files. Presentation files are usually comprised of a number of slides or images, but may also include audio. Presentation applications can provide a series of slides as a “slideshow” for display on a local computer monitor, projectors connected to the local computer, or some other display device connected to the computer.

Instant messaging applications provide a communication channel for business and personal use. Instant messaging allows two or more users to communicate over the Internet. Once a connection is formed between messaging application users, the users may begin a “chat” session and send text to each other through their messaging applications. More recent messaging applications implement other communication channels as well, such as audio signal and webcam signal channels.

Though instant messaging is useful for instantly exchanging limited formats of information, the options for sharing business information instantly over large geographic instances are limited.

### SUMMARY

The present technology, roughly described, pertains to providing a presentation as a video stream over a messaging network. The presentation may be a slide show file, a collection of images, or some other file having images which can be navigated by a user. As a user navigates through images, pages or other content of the presentation, the presentation application generates a video feed signal. The video signal includes the user navigation through the presentation and is sent to a messaging application. The messaging application processes the video signal into a video stream that is compatible with the messaging application. The messaging application then broadcasts the video stream over a messaging network during a messaging session. The messaging application may also communicate any audio associated with the presentation over a messaging audio channel, as well as traditional text, a web cam signal, and other data.

In some embodiments, the presentation application generates a series of bitmaps in response to user navigation of a selected presentation file. In this case, a bitmap is generated for each new image or page of the presentation as it is accessed by a user in a presentation application. The bitmaps are then provided to the messaging application. The messaging application generates a video stream from the received bitmaps and sends the video stream to session members over the messaging network.

In some cases, a user who broadcasts a presentation file during a messaging session may also transmit a webcam video signal during the session. When a user webcam signal is broadcast over the messaging session in addition to the generated video stream, the generated video stream may be sent by a messaging application associated with the actual user or a virtual user. When a user's messaging application transmits the generated video, the video may be combined with the user webcam signal and/or other data by the messaging application. When a second instance of the messaging application is used, it is associated with a virtual user and transmits the generated video signal over the messaging session separately.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of an embodiment of a system for showing a presentation file using a client-based messaging application.

FIG. 1B is a block diagram of an embodiment of a system for sharing a presentation file using a virtual user.

FIG. 2 is a block diagram of an embodiment of a system for sharing a presentation file using a browser-based messaging application.

FIG. 3 is a computing environment for implementing the present technology.

FIG. 4 is a flowchart of an embodiment of a method for providing a presentation file over a messaging network.

FIG. 5 is a flowchart of an embodiment of a method for identifying a presentation file to be sent over a messaging network.

FIG. 6 is a flowchart of an embodiment of a method for providing a video signal to a messaging application.

FIG. 7 is a flowchart of an embodiment of a method for encoding a video stream from a received bitmap.

FIG. 8A is an example of a page in a presentation.

FIG. 8B is an example of a frame captured by a web camera.

FIG. 8C is an embodiment of an interface for providing a presentation over a messaging network.

### DETAILED DESCRIPTION

Technology is disclosed herein wherein a presentation can be broadcast over a messaging network as a video stream. A presenter may access and navigate through pages of a presentation. As the presenter navigates through presentation images, pages or other content of the presentation, the changing images or other content is shown in the video stream broadcast. As a result, a presenter may instantly communicate a presentation to users of the messaging service, without requiring additional servers or other hardware in addition to those included in the messaging network.

The presentation may be a slide show file, a collection of images, or some other file having images which can be navigated by a user. For example, a presentation file may include a number of images. A presenter may “navigate” through the presentation by providing input into a presentation application. In response to the input, the presentation application may display different images of the presentation. As a user navigates through the presentation, the presentation application can generate a video signal. The video signal reflects user navigation through the presentation and is transmitted to a messaging application. The messaging application receives the video signal from the presentation application. The received video signal is derived from presentation data. In this case, the received video signal may be processed to retrieve the images, pages or other content of the presentation as the user navigates the presentation.

The messaging application may process the received video signal, derive a video stream from the video signal, and transmit the video stream to one or more other users. The users receiving the video stream are located at client computers over a messaging network and engaged in a messaging session with the presenter.

The messaging application processes the video signal to convert it into a video stream. The video stream is one that is compatible with the messaging application and may be broadcast during a messaging session. The messaging application then broadcasts the video stream during a messaging session over a messaging network. The messaging application may also communicate any audio associated with the presentation over a messaging audio channel, as well as traditional text, a web cam signal, and other data.

In some embodiments, the presentation application generates one or more bitmaps in response to user (presenter) navigation of a selected presentation file. In this case, a bitmap is generated for each new image or page of the presentation as it is accessed by a user in a presentation application (or in response to any other change in the page of the presentation). The bitmaps are then provided to the messaging application. The messaging application generates a video stream from the received bitmaps and sends the video stream to session members over the messaging network. In generating the video stream, the messaging application may send images over a video channel associated with the messaging session at a particular video channel rate, for example one frame per second. In this case, the broadcast of the dynamic presentation content will be updated at the corresponding video channel rate. If the presentation does not change for a period of time, the presentation application may either send the same image over the video channel or wait until the image changes (e.g., until a new bitmap is received). The receiving messaging applications will either display the last received video frame or each (non-changing) video frame during the period in which the presentation does not change. In either case, the broadcast will appear the same until the next bitmap is received, processed, and corresponding video stream content is broadcast over the messaging network.

In some cases, a messaging application may broadcast a presentation file and a webcam signal during a messaging session. When broadcasting both the webcam signal presentation video stream, the presentation video stream may be sent by a messaging application associated with the actual presenter or a virtual presenter. When a presenter's messaging application transmits the generated video stream, the stream may be combined with the webcam signal by the messaging application.

When the presenter messaging application is not used to transmit the video stream, the video stream can be broadcast by a messaging application associated with a virtual presenter (or virtual user). The virtual user messaging application can run in the background of the client device operating system and transmit the generated video signal over the messaging session. In this case, the virtual user messaging application can have a separate login than that of the presenter, but may be implemented on the same machine as the user messaging application. Using a virtual presenter messaging application to broadcast a presentation allows the presentation to be shared within a messaging session without having to splice, interleave or otherwise combine a video signal associated with the presenter's messaging application (e.g., a web cam) with the presentation video stream. Use of a virtual presenter (or user) messaging application is discussed in more detail below.

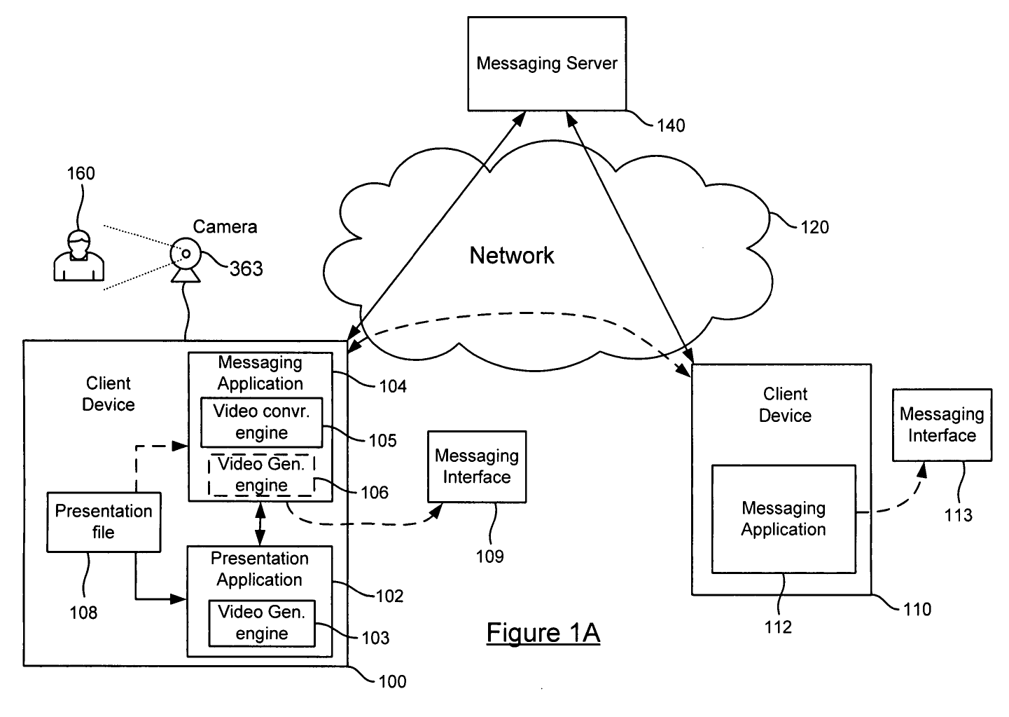

In some embodiments, providing a presentation over a messaging network may be implemented using a client based application. FIG. 1A is a block diagram of an embodiment of a system for broadcasting a presentation file using a client-based messaging application. The system of FIG. 1A includes client device 100, client device 110, network 120 and messaging server 130. In embodiment, client device 100 and client device 110 may communicate with each other and with messaging server 130 over network 120. Network 120 may be implemented as the Internet or some other network.

Client device 100 includes messaging application 104, presentation application 102 and presentation file 108. Messaging application 104 may communicate with presentation application 102. Both messaging application 104 and presentation application 102 may access presentation file 108.

Messaging application 104 is a client-based application which accesses a messaging service provided by messaging server 140. A presenter may use messaging application 104 to broadcast a presentation file to other users whom are members of a messaging session along with the presenter. In one embodiment, messaging application 104 may be implemented as “Windows Messenger” or “Microsoft Messenger for Mac”, both by Microsoft Corporation, of Redmond Wash.

Messaging application 104 may include video conversion engine 105 and video generation engine 106. Video conversion engine 105 may generate and/or encode a video stream from one or more received video signals. The video signals may be received from video generation engine 106, presentation application 102, webcam 363 or some other source. In one embodiment, the two or more received video signals are combined into one video stream by embedding a first video signal inside another video signal. In this case, the multiple video signals processed by video conversion engine 105 include a video signal generated from presentation application 102 and a webcam signal from webcam 363.

Video generation engine 106 may optionally be implemented in messaging application 104, as indicated by the dashed lines of engine 106. Video generation engine 106 may generate a video signal in response to user navigation through a presentation. In this case, a user may access, load and navigate through a presentation file using messaging application 104. In some embodiments, a user may access, load and navigate through a presentation file using presentation application 102. Accessing, loading and navigating through a presentation file are discussed in more detail below.

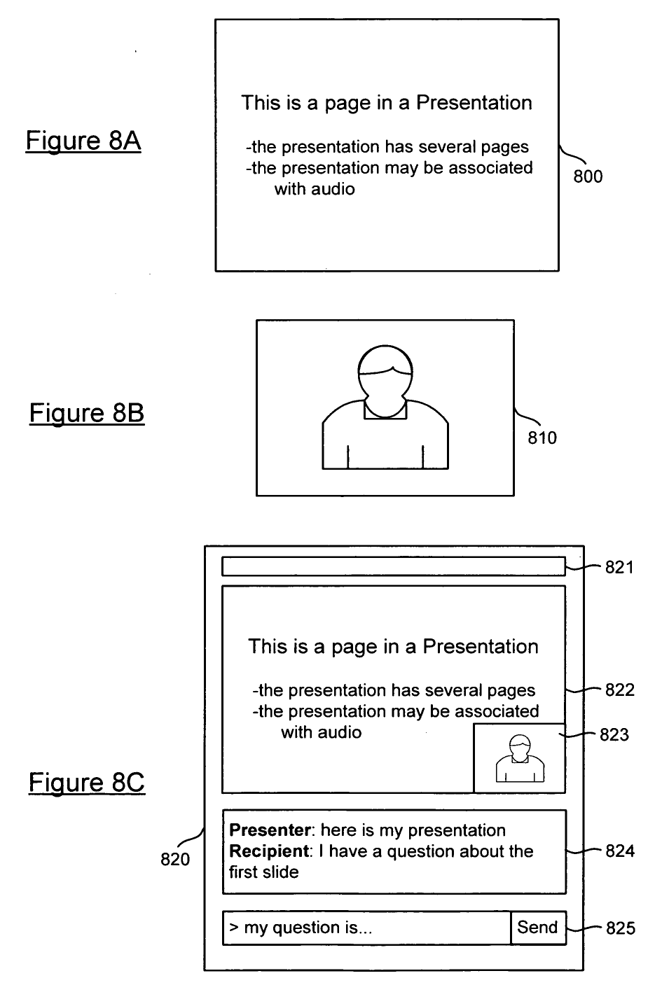

Messaging application 104 also implements messaging interface 109. Messaging interface 109 is an interface for implementing a messaging service. The interface may provide information such as a list of user contacts, online information for each contact, online information for the user, and other information. When a user provides input into the messaging interface to initiate a chat and create a messaging session, a second messaging interface may be provided. The second messaging interface allows the user to instant message with other users, as well as broadcast a presentation during the messaging session. An example of second messaging interface 109 is discussed in more detail below with respect to FIG. 8C.

Presentation application 102 enables a user to create, edit, manage and present presentation files. For example, presentation application 102 may be a slide show application, picture viewing application, or some other application. In one embodiment, presentation application 102 is implemented as “Microsoft PowerPoint” or “Microsoft PowerPoint for Mac,” both by Microsoft Corporation.

Presentation application 102 includes video generation engine 103. Video generation engine 103 may generate a video signal which captures user navigation through a presentation file. For example, presentation application may load presentation file 108. Once the file is loaded, a user may provide input that the file should be broadcast over a messaging network. After receiving this input, video generation engine will generate a video signal from the presentation image displayed to the user of presentation application 102. Thus, the generated video signal will first show an image of the first page of the presentation. As the user navigates through the presentation by proceeding to different presentation pages, the generated video signal will be updated by presenting those pages as the user selects them. Put another way, the generated video signal provides in video form what the user sees in a display interface of presentation application 102 while the user navigates through the presentation. The generated video signal is then sent from presentation application 102 to messaging application 104.

In some embodiments, the video signal generated by video generation engine 103 may be any video signal that is recognizable by the operating system of the computer on which presentation application 102 is running. In some embodiments, the operating system of the computer may be implemented by “Windows XP,” of Microsoft Corporation. In some embodiments, the operating system may be implemented by “Mac OS X Tiger,” of Apple Computer, Incorporated, of Cupertino, Calif. In some embodiments, other operating systems may be used. The video signal may be transmitted to messaging application 104 from presentation application 102 by inter-application communication channels implemented by the corresponding operating system.

In some embodiments, presentation application 102 can generate and transmit bitmaps to messaging application 104. In this case, as a user navigates between different pages of a presentation, a bitmap is generated each time the presentation display changes. The generated bitmaps are then sent to messaging application 104. Video conversion engine 105 then converts the bitmaps into a video stream compatible for broadcast over the messaging network.

Presentation file 108 may reside in local or remote memory associated with client device 100, and may be accessed by presentation application 102. In some embodiments, presentation file 108 may be accessed by browser application 104, as indicated by the dashed arrow between presentation file 108 and messaging application 104. In any case, presentation file 108 may be implemented as a Microsoft PowerPoint file (a ppt format). Presentation file 108 may include one or more pages of slides, images, audio content, and/or other data associated with a presentation.

Client device 110 includes messaging application 112, which provides messaging interface 113. Similar to messaging application 104, messaging application 112 is a client-based application for providing a messaging service to a user of client device 110. A user of client device 110 may enter a messaging session through messaging application 112 with the presenter using messaging application 104. The user of messaging application 112 may then receive a broadcast of a presentation from the presenter using messaging application 104.

One example of a process for establishing a messaging session using a browser based messaging system such as that of FIG. 1 may be implemented as follows. Users of messaging application 104 (presenter) and 113 (user whom receives a broadcast) access a login interface provided by application 104. Each user enters their corresponding login information, such as a username and a password, into a form within the login interface. Each messaging application may then send a login request to messaging server 140. Web server 140 receives the login request, determines whether the login information matches a user account, and provides a login response. In one embodiment. Messaging server 140 compares the login information to user account information stored at server 140 or otherwise accessible to server 140. If messaging server 140 determines the received login information for a particular user matches a user account, a user contact list and other information is returned to the requesting messaging application in a login response. If the login information did not match a user account, a failed attempt is communicated to the requesting messaging application. Upon a successful login, the messaging application provides messaging interface 109 with the user's contacts.

After the user is logged into the messaging service, the user may initiate a messaging session with one or more other logged in users. To initiate a session, the user may select a contact from contacts listed in messaging interface 109. Upon selecting a contact, a second messaging interface can be provided. An example of the second messaging interface is shown in FIG. 8C and discussed in more detail below. In one embodiment, a user initiating the chat (messaging session) may configure protocols or formats associated with the messaging session, such as video protocols and audio formats. Once the session is initiated, users invited to the session may exchange text, video and audio content to others in the session. At this point, the messaging applications may communicate data directly to other messaging applications involved in the messaging session.

In some embodiments, when a user wishes to share a presentation over a messaging network, the presentation is encoded as video and transmitted over the network by a messaging application associated with a virtual user. FIG. 1B is a block diagram of an embodiment of a system for sharing a presentation file using a virtual user. Client device 150 includes messaging application 104, messaging application 160 and presentation application 102. Messaging application 104 is associated with a user, and messaging application 160 is associated with a virtual user. Messaging application 160 is invoked in response to a request to send a presentation over the messaging network. In this embodiment, the encoded video generated from selected presentation file 108 is sent over a video channel associated with virtual user messaging application 160. The messaging application for the virtual user may have separate login credentials than messaging application 104, but is added to the same messaging session as the actual user. Thus, client device 100 may be associated with two separate audio channels and two separate video channels. Generating a messaging application for a virtual user to send encoded video over a messaging network is discussed in more detail below.

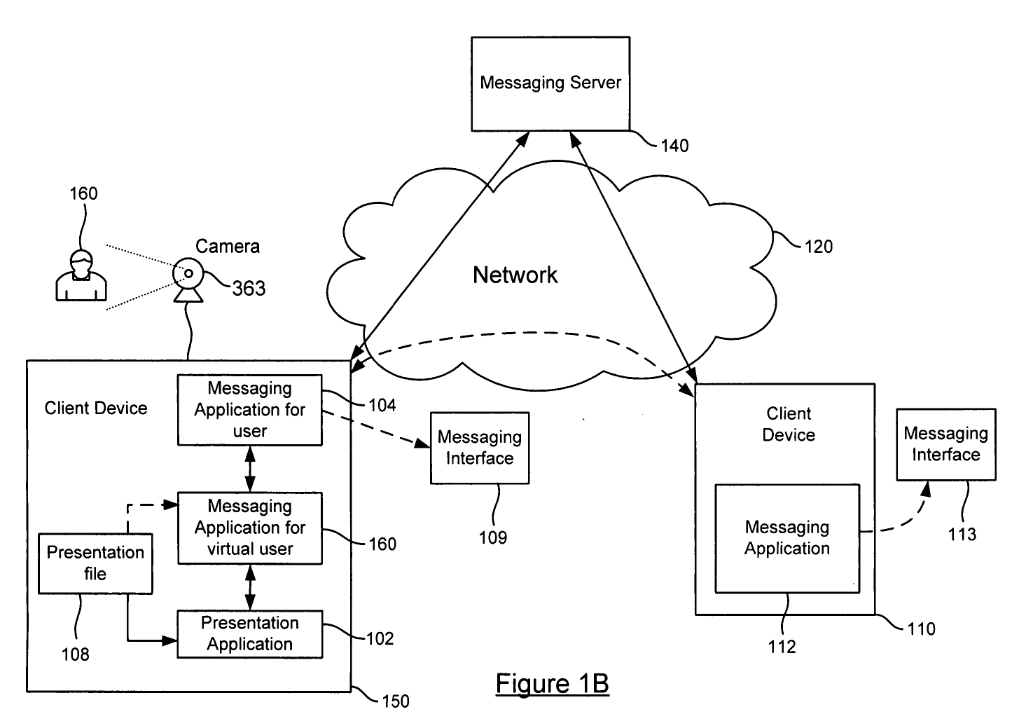

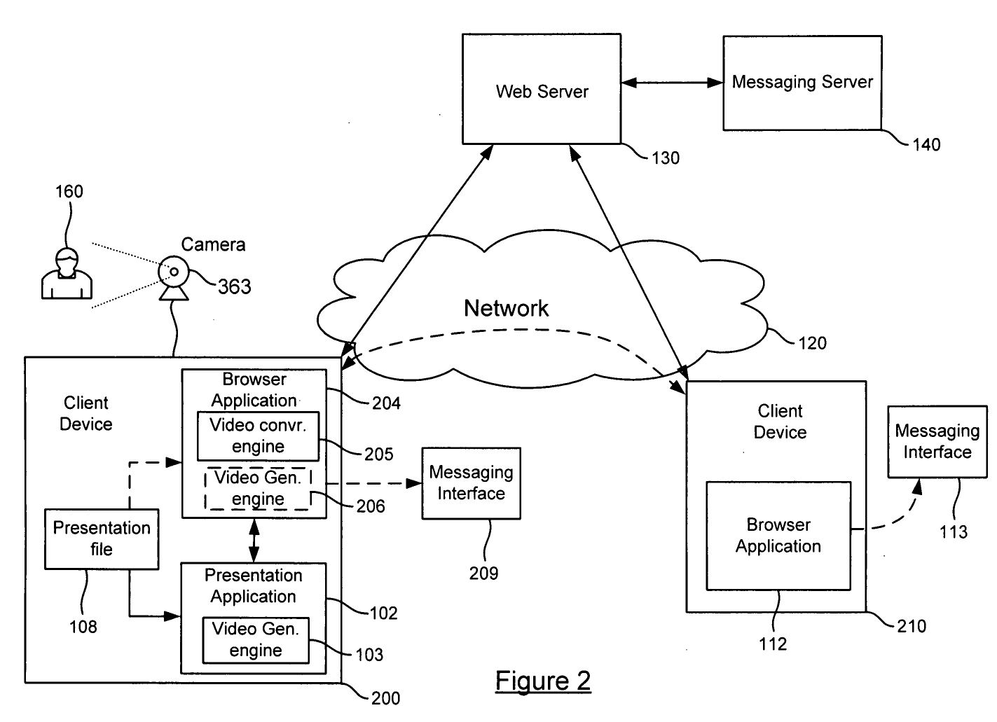

FIG. 2 is a block diagram of an embodiment of a system for sharing a presentation file using a browser-based messaging application. FIG. 2 includes client device 200, client device 210, web server 130, messaging server 140, network 220, webcam 363 and user 160. Client device 200 and client device 210 may each communicate with web server 130 over network 220. Web server 130 may communicate with messaging server 140. In one embodiment, network 220 may be implemented as the Internet. Webcam 363 (or camera 363) is discussed in more detail below with respect to FIG. 3.

Client device 200 includes browser application 204, presentation application 102 and presentation file 108. Presentation application 102 and presentation file 108 are the same as those in FIGS. 1A-1B. Browser application 204 may be implemented by any web browser application. In one embodiment, browser application 204 may be implemented by “Internet Explorer,” by Microsoft Corporation, of Redmond, Wash.

Browser application 204 may provide content pages received from web server 130. The content pages may implement video conversion engine 205, video generation engine 206 and messaging interface 209. Video conversion engine 205 may generate and/or encode a video stream from one or more received video signals. Video generation engine 206 may optionally be implemented in browser application 204, as indicated by the dashed lines of engine 206. Video conversion engine 205 and video generation engine 206 may perform the same functionality as discussed above with respect to video conversion engine 105 and video generation engine 106, respectively, but may be implemented from a browser application. For example, video conversion engine 205 and video generation engine 106 may be implemented using script code or some other code included into a content page.

Messaging interface 209 is an interface for implementing a messaging service. The interface is similar to interface 109 of FIGS. 1A-1B, but can be implemented by a content page retrieved by browser application 204. An example of messaging interface 209 is discussed in more detail below with respect to FIG. 8C.

Client device 210 is similar to client device 200. In particular, client device 210 includes browser application 112, which provides messaging interface 113. Browser application 112 may retrieve a content page provided by web server 130, in a manner similar to that described above for browser application 204. The content page may include code for providing messaging interface 113. While in a messaging session, a user may send and receive data over the messaging network through browser application 112. The data may be sent and received directly with client device 210 (as indicated by the dashed line between client device 200 and client device 210) or indirectly through web server 130.

Web server 130 implements a web service which may be accessed by browser applications 204 and 112. The web service may provide an instant messaging service. To implement the messaging service, web server 130 may access data from messaging server 140 and provide messaging data and other data to browser applications 204 and 112. Messaging server 140 may store data such as user login data, user account information, user contact lists, and other information associated with providing a messaging service to users.

One example of a process for establishing a messaging session using a browser based messaging system such as that of FIG. 2 may be implemented as follows. Users of browser application 204 and 113 access a login web page associated with the browser based messaging service. Each user enters login information, such as a username and a password, into a form provided by their respective browser. Each browser may then send a login request to web server 130. Web server 130 receives the login request, determines whether the login information matches a user account, and provides a login response. To determine if the login information matches a user account, web server 130 may send the login information to messaging server 140. Messaging server 140 compares the login information to user account information stored at server 140 or otherwise accessible to server 140. If messaging server 140 determines the login information matches a user account, a user contact list and other information is provided to web server 130. If the login information did not match a user account, the failed attempt is communicated to web server 130. Web server 130 then forwards the received response information to the corresponding requesting user's browser application. Upon a successful login, the browser application provides messaging interface 209 with the user's contacts.

After the user is logged into the messaging service, the user may initiate a messaging session with one or more other logged in users. To initiate a session, the user may select a contact from contacts listed in messaging interface 209. Upon selecting a contact, a second messaging interface can be provided. An example of the second messaging interface is shown in FIG. 8C and discussed in more detail below. In one embodiment, a user initiating the chat may configure protocols or formats associated with the messaging session, such as video protocols and audio formats. Once the session is initiated, users invited to the session may exchange text, video and audio content to others in the session.

FIG. 3 is a block diagram of an embodiment of a computing environment for implementing the present technology. In one embodiment, the computing environment of FIG. 3 may be used to implement client devices 100-110, web server 130, messaging server 140, client devices 200-210 and messaging server 230.

FIG. 3 illustrates an example of a suitable computing system environment 300 on which the invention may be implemented. In one embodiment, computing system environment 300 may be used to implement client device 100, 110, 200, 210, 250, web server 130 and messaging server 140. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the invention includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 30 through input devices such as a keyboard 362 and pointing device 361, commonly referred to as a mouse, trackball or touch pad. Camera 363 may also provide input into computer 30, and is described in more detail below. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through a output peripheral interface 390.

As mentioned above, camera 363 may provide input into user input interface 360. Camera 363 may be implemented as a digital camera, video camera, web camera or webcam, or other device which captures images and provides data regarding the images. A web camera may be implemented by a device which captures a series of images and provides data associated with those images as a video stream or video signal. The webcam may be compatible with PC, Mac, or Unix based systems, and connect to computing environment 300 through a USB, Firewire, RCA, RJ-45, terminal block, or other connector type.

The camera may capture digital images at a preset interval frame rate or some other frame rate. The video stream from the webcam may be sent via wired or wireless connections to computer 300. Once received, the video stream may be routed and processed by one or more applications stored in memory 330 of the computer. In one embodiment, a video stream captured by a webcam may be routed to a browser application or a client-based messaging application.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

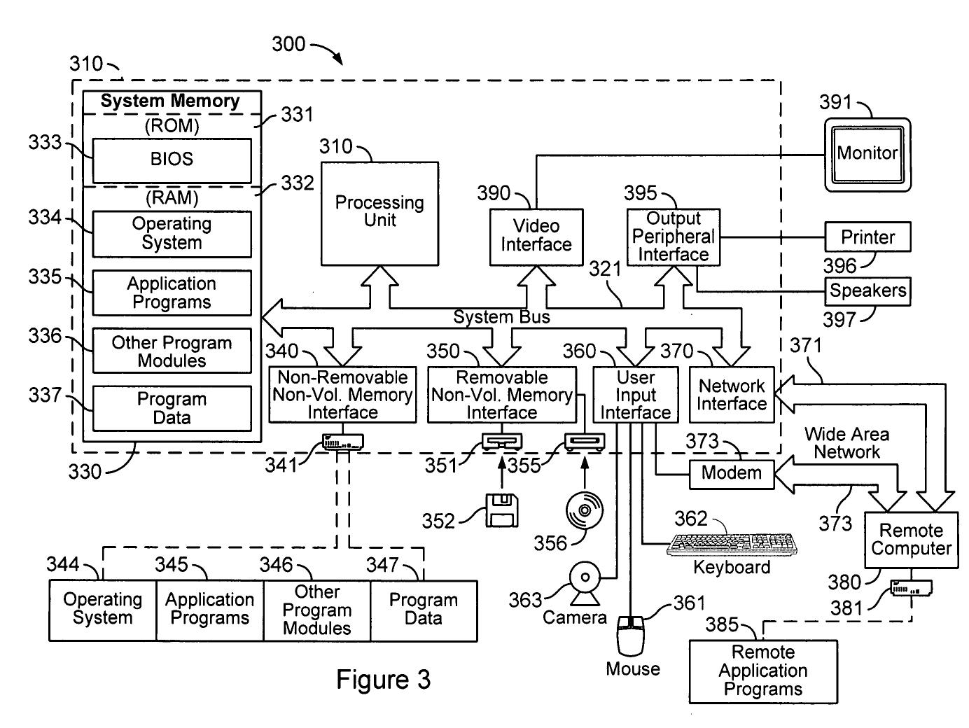

FIG. 4 is a flowchart of an embodiment of a method for providing a presentation file over a messaging network. For purposes of discussion, the flowchart of FIG. 4 will be discussed with reference to the client-based messaging application system of FIG. 2A. However, a browser-based messaging system could implement the flowchart of FIG. 4 as well. Session members log into messaging server 140 and create a messaging session at step 410. Performing login to a messaging service and generating a messaging session associated with messaging server 140 is discussed in more detail above.

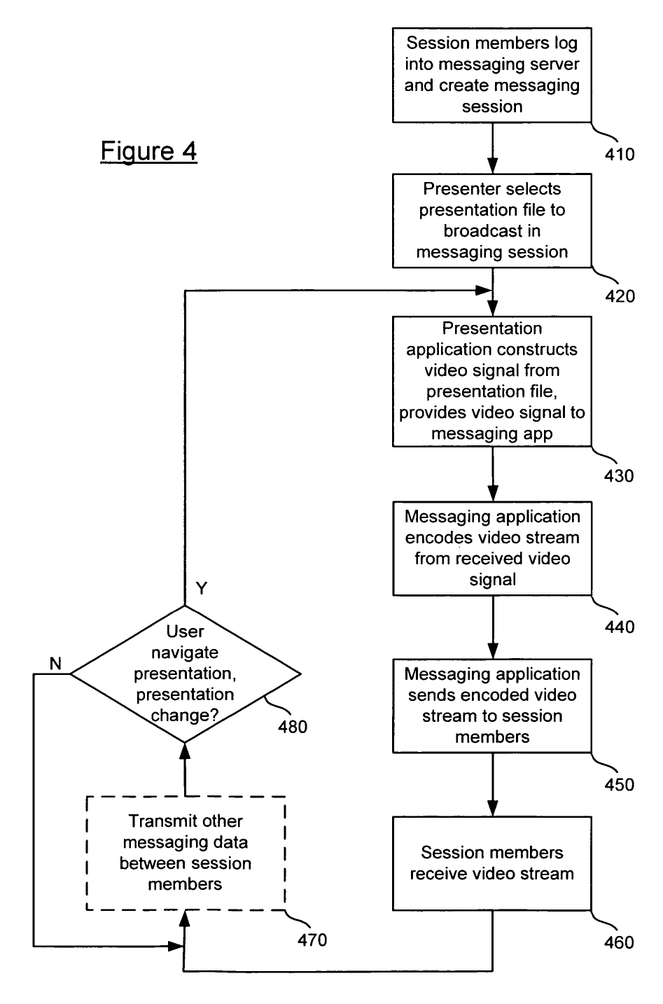

After establishing a messaging session, a presenter may select presentation file 108 to broadcast during the session at step 420. Selecting presentation file 108 to be broadcast may be performed through messaging application 204 or presentation application 102. In one embodiment, messaging application 204 may invoke presentation application 102 for the user. In some cases, a user may separately invoke presentation application 102 in order to select presentation file 108. An embodiment of a process for selecting a presentation file 108 to broadcast is discussed in more detail below with respect to FIG. 5.

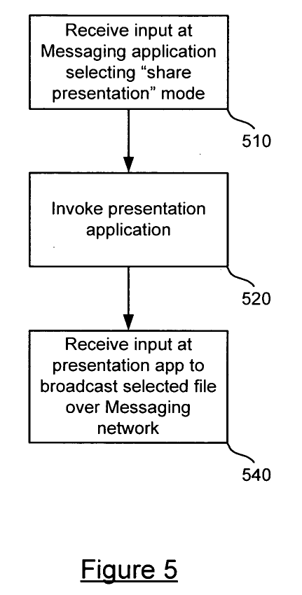

Presentation application 102 constructs a video signal from presentation file 108 and provides the video signal to messaging application 204 at step 430. In some embodiments, the video signal generated by video generation engine 103 may be any video signal that is compatible with the operating system of the computer on which presentation application 102 is running. The video signal may be transmitted to messaging application 204 from presentation application 102 by inter-application communication channels implemented by the corresponding operating system. Generation of a video signal from presentation file 108 is discussed in more detail below with respect to FIG. 6

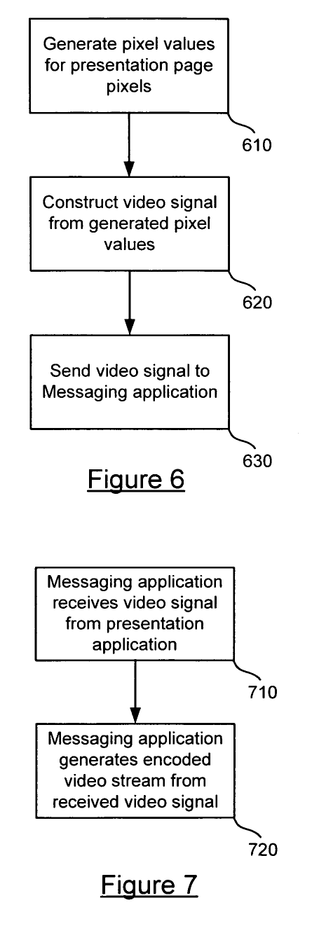

Messaging application 204 receives the video signal from presentation application 102 and encodes a video stream from the received signal at step 440. In this embodiment, the video signal generated from presentation file 108 is used for generation of a video stream to send over a messaging session video channel. Encoding the video stream may depend on the video CODEC used by messaging application 204, the protocols used by the video channel used in the messaging session, the number of streams to encode, and other information. For example, messaging application 204 may apply an instant messaging CODEC to the received signal to encode the video stream to broadcast during the messaging session. Examples of a suitable CODEC include H261, H263, H264, RT Video, and other CODECs. Processing the video stream with protocols associated with the messaging video channel may include specifying the CODEC used to encode the video stream, specifying the data type as video, indicating other communication information, and performing other processing. Encoding a video stream from one or more received video signals is discussed in more detail below with respect to FIG. 7.

In one embodiment, video generation engine 103 of presentation application 102 may generate a bitmap from presentation file 108. The bitmap may be in one of several types of formats, including .JPG, .TIFF, .JIF, or some other format. In some embodiments, the bitmap may be generated by an image generation engine (not pictured in FIG. 2A) in either a browser application or a messaging application on a client device. In this case, the bitmap is not generated on the presentation application itself. In any case, messaging application 204 can encode a video stream from the received bitmap. As discussed above, encoding the video stream would depend on the video CODEC and protocols used by the messaging application, as well as other factors.

After encoding the video stream, messaging application 204 sends the encoded video stream to session members at step 450. The encoded video stream is sent over the messaging network through a video channel associated with the messaging session. In one embodiment, audio data may also be sent. The audio may be sent over an audio channel or as part of the encoded video. Next, session members receive the video stream at their corresponding messaging applications at step 460. In one embodiment, upon receiving the video stream, the video is processed and displayed in a messaging interface associated with the receiving user's messenger application. An example of a messaging interface is discussed below with respect to FIG. 8C.

Other messaging communication data may be sent between session members at step 470. Other messaging communication data may include text, webcam video data, audio data, files or other data. In some embodiments, the additional messaging data may be sent during, before, or after the video steam is sent. This step is optional, as indicated by the dash line comprised in step 470 in the flowchart of FIG. 4.

A determination is made at step 480 as to whether the user navigates through the presentation or the presentation otherwise changes at step 480. If the presentation does not change, the flowchart of FIG. 4 returns at step 470. If the presentation changes, the flowchart continues to step 480 where the presentation application constructs a video stream (or modifies an already generated video stream) to reflect the change. Step 480 is discussed in more detail below with respect to FIG. 9.

FIG. 5 is a flowchart of an embodiment of a method for identifying a presentation file to be sent over a messaging network. In one embodiment, the flowchart of FIG. 5 provides more detail for step 420 of FIG. 4. First, input is received at messaging application 204. The input may be a selection that initiates a “shared presentation” mode in the presentation application. In one embodiment, the input is received through messaging interface 209. After receiving the input, presentation application 102 is invoked at step 520. In one embodiment, presentation application 102 may be invoked by messaging application 204. In some embodiments, the presentation application may be invoked by a user rather than messaging application 204. Messaging application 204 may also invoke a second messaging application to be associated with a virtual user. In this case, messaging application 204 may invoke message application 260 for a virtual user (as in the system of FIG. 2B). After invoking presentation application 102, messaging application 204 waits for a video signal from the presentation application 102.

Input is received at presentation application 102 to select and broadcast a presentation file over a messaging network at step 540. In one embodiment, receiving input includes receiving a user selection of presentation file 108. The file may be selected through a presentation application interface provided by presentation application 102.

In some embodiments, messaging application 204 may access the selected presentation file 108. In this case, messaging application 204 may receive input through an interface selecting a shared presentation mode at step 5 10, provide an interface through which the presentation file 108 may be selected, and receive input to select the particular file at step 540.

FIG. 6 is a flowchart of an embodiment of a method for providing a video signal to a messaging application. In one embodiment, FIG. 6 provides more detail for step 430 of FIG. 4. First, pixel values are generated for the presentation page pixels at step 610. In one embodiment, the generated pixel values may include information for each pixel or “bit” in the display space or image of the page being rendered. In some cases, the pixel information may only indicate transition information for neighboring bits. Thus, rather than indicate a value for every pixel, the pixel information indicates changes between neighboring pixels. This method of expressing pixel values can save memory space when the image includes blocks of uniform color. In some cases, the pixel values may be generated for a rastergraphic from a vector graphic. A vector graphic may include data describing a circle, line, square or other drawings or shapes and their position in the image. From the shape descriptions, a rastergraphic can be generated which describes the pixels comprising the image of the vector graphic.

A video signal is generated from the pixel values at step 620. In one embodiment, the video signal is in a format which is recognizable by the operating system of the computer. Examples of formats recognizable by a “Windows” operating system include audio video interleave format (avi), windows media format (wmf), motion picture experts group format (mpeg) and other formats.

After constructing the video signal, the video signal is sent to messaging application 204 at step 630. Transmission of the video signal may be performed by presentation application 102 or messaging application 204. In the case of a virtual user, the video signal is sent to messaging application 260 associated with the virtual user. In one embodiment, audio associated with presentation file 108 from which the pixel values are generated is sent to the appropriate messaging application as well.

In some embodiments, bitmaps are generated from the pixel values at step 620. Example formats for the bitmaps may include a .bmp, .tiff, .jif, .jpeg, or other image formats. The generated pixel values are then transmitted to messaging application 204.

FIG. 7 is a flowchart of an embodiment of a process for generating an encoded video stream from a received video signal. In one embodiment, FIG. 7 provides more detail for step 440 of FIG. 4. First, messaging application 204 receives a video signal image at step 710. The video signal image may be received from presentation application 102. In some embodiments, the video signal image may be generated by messaging application 204 itself. In particular, the video signal image may be generated and transmitted by video generation engine 206 to video conversion engine 205. The messaging application which receives the video signal image may be a messaging application used by a user or a messaging application associated with the virtual user. After receiving the video signal image, messaging application 204 generates an encoded video stream from the received video signal image. In one embodiment, video stream generation engine 106 encodes the received video signal into a video stream using the appropriate CODEC and video in protocols. In one embodiment, the encoded video stream may consist of a stream or series of images. In some cases, video signals are received only when the image within a presentation file changes. Thus, the encoded video stream will consist of a single frame associated with the received image and will not include any other data until a new image is received by video conversion engine 105. Examples of a suitable CODEC for encoding a video stream include VDO Live, light VDO, clear video, MPEG-4 and other video formats.

FIGS. 8A-8C provide examples of video signal content and that content provided in a messaging interface. FIG. 8A is an example of a page 800 of a presentation. Page 800 may be accessed from within a presentation application. Page 800 includes a first line of“This is a page in a presentation.” Below the first line are two additional lines. A video generation engine may generate a video signal which includes the image of page 800 while the page is viewed through a presentation application. In some embodiments, a bitmap can be generated from the page. The video signal or bitmap generated from page 800 may then be used to generate an encoded video stream which is sent over a messaging network.

FIG. 8B is an example of a frame captured by camera 363 of FIGS. 1-3. Frame 810 is a digital image and may be one of a series of images in a video signal generated by camera 363. The video signal generated by camera 363 can be sent over a messaging video channel associated with a messaging session.

FIG. 8C is an embodiment of a messaging interface 820 for broadcasting a presentation during a messaging session. In one embodiment, messaging interface 820 is provided to a user in response to user selection of a user contact in a first messaging interface. Interface 820 includes interface control bar 821, video window 822, chat window 824 and text entry window 825. Interface control bar 821 may include buttons, drop down menus or other selectable objects to configure interface 820. In particular, interface control bar 821 may include user status information (indicating whether the user is online, away, hidden, etc.), user contacts, information regarding other session members, an alert indicator, a tool bar, user's name and/or other information.

Video window 822 provides the encoded video stream sent by a presenter from one messaging application to other session members at other messaging applications. In the embodiment illustrated in FIG. 8C, a video stream is constructed from two video signals. The video signals are associated with a presentation and a webcam. In particular, the presentation generated signal is associated with page 800 of FIG. 8A and the webcam signal is associated with the frame of FIG. 8B. In the broadcast signal frame illustrated in interface 820, frame 810 is embedded in the lower right hand corner of page 800. As images from the camera or presentation change, a new encoded video stream is generated and broadcast to recipients in video window 822. In some cases, a messaging interface 820 may include multiple video windows. In this case, one video window may include a video stream associated with a presentation and another video window may include a video stream associated with a webcam.

Chat window 824 provides information regarding previous text messages sent and received by a recipient during the messaging session. In particular, a presenter has typed text of “here is my presentation.” In response, the recipient has typed “I have a question about the first slide.” Text entry window 825 allows a user to enter new text to be sent to other users within the session. The text in text entry window 825 reads “my question is . . . ” In addition to text, other instant messaging functions (e.g., audio sharing and file sharing) may be performed while broadcasting the video stream derived from the presentation file and webcam signal.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for providing video stream over a network, comprising:
deriving an image for each page of a presentation file;
constructing a video stream associated with the derived images; and
broadcasting the video stream over a network by a messaging application.

2. The method of claim 1, wherein said step of deriving an image includes:
generating a video signal from accessed pages of the presentation application.

3. The method of claim 1, wherein said step of deriving an image includes:
generating a bitmap for each accessed page of the presentation application.

4. The method of claim 1, wherein said step of constructing a video stream includes:
receiving the images in the form of a video signal; and
applying a video CODEC to the video signal.

5. The method of claim 1, wherein said step of constructing a video stream includes:
invoking a secondary messaging application associated with a virtual user, the secondary messaging application invoked by a primary messaging application associated with a user; and
constructing a video stream by the secondary messaging application.

6. The method of claim 1, wherein said step of constructing a video stream includes:
embedding a second video stream into a portion of the constructed video stream.

7. The method of claim 1, wherein said step of constructing a video stream includes:
interleaving the constructed video stream with a secondary video stream.

8. The method of claim 1, wherein said step of sending the video stream includes:
receiving an audio stream associated with the presentation file; and
sending the received audio stream over the messaging network.

9. The method of claim 1, wherein said step of sending the received audio stream includes:
mixing the audio stream associated with the presentation file with an audio stream associated with a secondary audio stream;
sending the mixed audio stream over the messaging network.

10. The method of claim 1, wherein said step of sending the video stream includes:
sending the video stream to one or more members of a messaging session.

11. One or more processor readable storage devices having processor readable code embodied on said processor readable storage devices, said processor readable code for programming one or more processors to perform a method comprising:
receiving a video signal having presentation data;
constructing a video stream from the video signal; and
transmitting the video stream over a messaging channel.

12. The one or more processor readable storage devices according to claim 11, wherein said step of receiving a video signal includes:
receiving a video signal by a messaging application.

13. The one or more processor readable storage devices according to claim 11, wherein said step of constructing the video stream includes:
receiving a video signal; and
converting the video signal to a video stream compatible with a network messaging protocol.

14. The one or more processor readable storage devices according to claim 11, the method further comprising:
transmitting audio data associated with the video signal over the messaging channel.

15. The one or more processor readable storage devices according to claim 11, the method further comprising:
transmitting text data over the messaging channel while transmitting the video stream.

16. A system for providing a video stream over a network, comprising:
a video generation engine that generates a video signal from a presentation file;
a video conversion engine that encodes a video stream from the generated video signal; and
a first messaging application transmitting the encoded video stream over a messaging channel.

17. The system of claim 16, wherein the messaging application includes the video conversion engine.

18. The system of claim 16, further comprising:
a second messaging application associated with a user, the first messaging application associated with a virtual user and invoked by the second messaging application.

19. The system of claim 16, wherein the video generation engine is contained in a slide show application.

20. The system of claim 16, wherein the messaging application includes the video generation engine.
